(19) United States
(12) Patent Application Publication
(10) Pub. No.: US 2012/0085330 A1
(43) Pub. Date: Apr. 12, 2012

(54) Underwater Spear Gun & Method of Specimen Collection

(76) Inventors: Robert E. Hickerson, Vero Beach, FL (US); Maria E. de la Peña, Mexico City (MX)

(21) Appl. No.: 13/269,924

(22) Filed: Oct. 10, 2011

Related U.S. Application Data
(60) Provisional application No. 61/391,717, filed on Oct. 11, 2010.

(51) Int. Cl. F41B 7/04; A01K 81/06

(52) U.S. Cl. 124/22

(57) ABSTRACT

The present invention includes a projectile assembly for underwater hunting and specimen collection comprising at least a cylindrical launcher, a projectile spear initially kept within the cylindrical launcher, and an elastic tension band attached to the cylindrical launcher. The invention also includes a method of capturing underwater prey or specimens using the projectile assembly. The cylindrical launcher can include a launch cap with a hole, through which the launch end of the spear is slotted prior to launching the spear. The projectile spear is launched by pulling the launch end of the spear through the cylindrical barrel and through the hole of the launch cap, placing against the middle section of the elastic tension band and pulling the tension band tight and away from cylindrical barrel along its longitudinal axis, then releasing the elastic tension band.

### CROSS-REFERENCE TO RELATED APPLICATIONS

This application claims the benefit of U.S. Provisional Patent Application No. 61/391,717, filed Oct. 11, 2010, which is incorporated herein by reference.

### FIELD OF THE INVENTION

Aspects of the invention relate generally to hunting weapon or specimen capture device, more specifically to a projectile assembly appropriate for use in capturing underwater species, including lionfish.

### BACKGROUND OF THE INVENTION

The lionfish is a venomous creature native to Indo-Pacific that has no known predators in the western hemisphere. Lionfish may live longer than 15 years, and can reach sizes exceeding 20 inches. Lionfish possess venomous spines, which deter predators and inflict serious stings and reactions in humans. They are very resilient to a broad variety of environments regarding depth, salinity, and temperature, and are often found on important coral reef habitats. Many lionfish prey are commercially, recreationally, and ecologically important species. Lionfish become sexually mature in less than 1 year, and a single female lionfish can spawn over 2 million eggs per year. Since their introduction in the Atlantic, they have reproduced at an alarming rate, and are able to disperse further through ocean currents.

The primary means of controlling the lionfish population in the western hemisphere is through manual collection of the species. Lionfish are edible and considered by some to be a delicacy. However, most collection efforts have been driven primarily for species control and to preserve the reef or other species-diverse habitat. Due to a lack of predators, lionfish will generally allow humans (and almost every other creature) to approach. Close range capture, therefore, is feasible. However, the presence of the venomous spines on the lionfish and risk of stinging, actual physical contact by a diver with the lionfish should be avoided as much as possible.

The traditional weapons of choice when dive or spear fishing are the pole spear, also sometimes known as the hand spear or gidgee, and the Hawaiian sling. A Hawaiian sling is akin to an underwater bow and arrow, since the spear and the propelling device are separate, while the pole spear has the sling (rubber loop) attached to the spear.

The Hawaiian sling operates much like a bow and arrow on land, but energy is stored in rubber tubing rather than a wooden or fiberglass shaft. With a Hawaiian sling, a loop of rubber tubing is attached to a block of material, often wood, with a hole drilled in it slightly larger than the shaft. The shaft is placed in the hole, notched in the loop and pulled back, tensioning the tubing. When the shaft is released, the tubing propels forward, faster and further than a diver could by hand.

A pole spear is an underwater tool used in spear fishing, consisting of a pole, a spear tip, and a rubber loop. The pole is usually between four feet and eight feet long and made of fiberglass, carbon fiber, aluminum or wood. Longer versions often break down into two or more pieces that screw together. The tip is either threaded to accept different kinds of spear tips or already has a fixed tip attached. The most popular spear tip on pole spears are the paralyzer (often called a three-prong), and the Tahitian shaft (a single pivoting barb). At the butt end of the spear is an elastic loop, usually made of surgical tubing or a band of rubber (a bicycle inner tube, for example).

The pole spear is operated by placing the rubber loop in the crook of the thumb, then reaching up the spear shaft to stretch the elastic band and grabbing the pole spear to hold the band in tension. On flimsy spears, it's useful to twist the spear as the band stretches to keep the spear from bending. Shooting the spear involves simply letting go of the spear shaft. The effective range of a pole spear is about the length of the spear, necessitating a close approach to the target.

Trigger-based spear guns are also known in the art. Types of spear include the pneumatic spear gun, which utilizes an air-driven piston or a CO₂ cartridge to drive the spear shaft down a rifle-like barrel, and the rubber-powered or sling type spear gun, in which one or more elastic bands propel the spear shaft. Many Caribbean islands do not allow species hunting with spear guns, particularly pneumatic spear guns.

Spear guns, and many Hawaiian slings and pole spears are generally constructed having lengths of some 3-6 feet or longer. Such a length makes them unwieldy for transportation, diving, stowage, and for close-range capture of species. Furthermore, use of such devices often propels long spears at high rates of speed or for significant distances (15 feet or more). If such spears miss their intended target, they can damage coral reefs or other environs.

### SUMMARY OF THE INVENTION

The present invention includes a projectile assembly for underwater hunting and specimen collection comprising at least a cylindrical launcher, a projectile spear initially kept within the cylindrical launcher, and an elastic tension band attached to the cylindrical launcher. The cylindrical launcher has the elastic tension band attached to one end (the tension or band end) of a cylindrical barrel on at least two points on the outside of the cylindrical barrel or to the attached handle. The cylindrical launcher also has a launch cap with a hole, through which the launch end of the spear is slotted prior to launching the spear. The projectile spear is launched by pulling the launch end of the spear through the cylindrical barrel and through the hole of the launch cap, placing against the middle section of the elastic tension band and pulling the tension band tight and away from cylindrical barrel along its longitudinal axis, then releasing the elastic tension band. The energy from the elastic tension band propels the spear through the launcher out its muzzle end and several feet further, in an approximately straight manner (though there is friction and drag from the water). If aimed correctly at the intended prey/specimen, the pronged end of the spear pierces or “catches” the intended prey/specimen. The diver operating the assembly device may then pick up the launch end of the spear in order to collect the intended prey/specimen. If desired, the diver/operator may insert the launch end of the spear back into the muzzle end of the cylindrical barrel, allowing the spear shaft to extend down the entire length of the tube and emerge out the launch cap through the hole provided. The shaft end can then be grabbed and the specimen then be released from the end of the spear head by simply pulling it against the end of the muzzle end of the tube thereby depositing the terminated specimen back onto the reef or inserting it into one's collection bag. In one embodiment, this places the specimen against the muzzle end of the barrel, and the specimen can be essentially pried off of the spear using the muzzle end of the barrel alone or using another object as well.

In some embodiments, the invention further comprises a handle attached to the cylindrical barrel.

In one preferred embodiment, the invention further comprises a removable cap on the muzzle end of the cylindrical barrel, which is removed prior to launch of the spear but kept in place as a safety device prior to launch.

In one embodiment, the invention further comprises an attachment component for the projectile assembly, which allows for the assembly to be transported hands-free by the diver. The invention is intended to be lightweight and portable.

The invention further includes a method of capturing underwater prey by using a projectile assembly. The diver or hunter first ensures that the projectile spear is in the cylindrical barrel with the launch end of the spear facing the band end of the barrel and the launch end extends out of the launch hole to contact the approximate middle of the elastic tension band. The hunter holds the projectile assembly steady with one hand. The hunter then places his or her index finger and thumb, or any convenient fingers, from the second hand on the launch end of the spear and pulls the spear back away from the muzzle end of the barrel to increase the tension in the elastic band. The hunter visually aligns the spear with the prey prior to launch. The hunter then releases the spear with the second hand, holding the assembly steady with the first hand, thus launching the spear down the muzzle end of the tube and out of the tube to make contact with the prey. In at least one embodiment of the invention, the hunter retrieves the spear with the prey attached and pulls the launch end of the spear back through the muzzle end of the barrel then the launch end and, if necessary, the launch hole, to release the prey from the spear and collect it, if desired.

### BRIEF DESCRIPTION OF THE DRAWINGS

The above and other objects, features, and advantages of the invention will become more apparent from the following description of certain preferred embodiments thereof, when taken in conjunction with the accompanying drawings in which:

FIG. 1 depicts a projectile spear according to one embodiment of the invention.

FIG. 2 depicts a top view cross section of a projectile assembly without a handle depicting the spear engaged prior to launch and cap on according to one embodiment of the invention.

FIG. 3 depicts a side view of a projectile assembly without a handle depicting the spear engaged prior to launch and cap on according to one embodiment of the invention.

FIG. 4 depicts a side view of a projectile assembly with a handle depicting the spear engaged and cap on according to another embodiment of the invention.

FIG. 5 depicts a top view cross section of a projectile assembly with a handle depicting the spear engaged prior to launch and cap on according to yet another embodiment of the invention.

FIG. 6 depicts a side view of a projectile assembly without a handle depicting the spear engaged and cap on prior to launch according to one embodiment of the invention.

FIG. 7 depicts a side view of a projectile assembly with a handle depicting the spear engaged according to another embodiment of the invention.

### DETAILED DESCRIPTION OF PREFERRED EMBODIMENTS

The present invention now will be described more fully hereinafter with reference to the accompanying drawings, in which preferred embodiments of the invention are shown. The invention may, however, be embodied in many different forms and should not be construed as limited to the embodiments set forth herein; rather, these embodiments are provided so that this disclosure will be thorough and complete and convey the scope of the invention to those skilled in the art. Like numbers refer to like elements throughout.

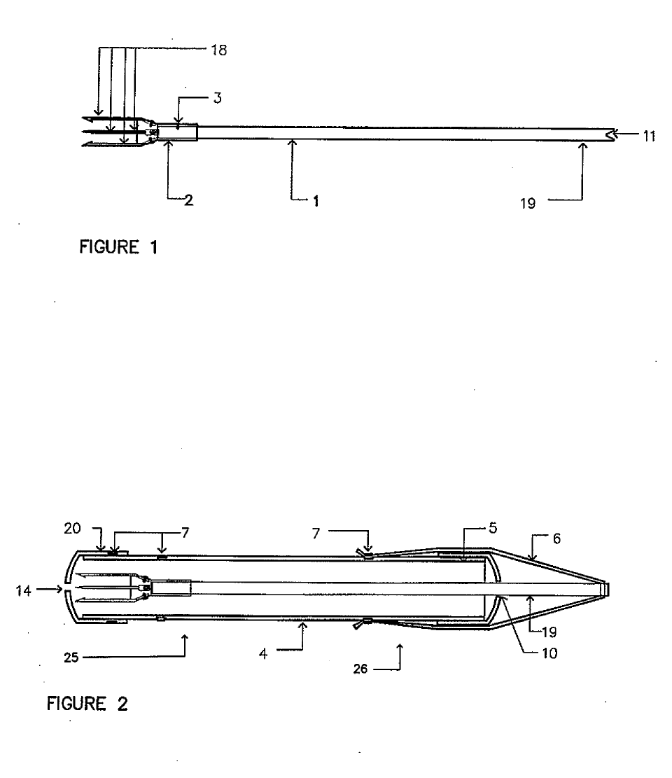

According to FIG. 1, the projectile spear is comprised of a shaft 1 and a pronged end or spear head affixed to one end of the shaft. The spear head has at least one prong 18 or pointed ends, preferably at least 3 prongs, most preferably at least 4 prongs. In preferred embodiments, the prongs have barbed steel ends on aluminum, stainless steel, or other suitable material base. As shown in FIGS. 2-7, the outside dimension of the cluster of pointed ends 18 shall be just slightly smaller than the inside diameter of the cylindrical body 4 of the assembly, so that the projectile spear will easily fit within the cylindrical base.

The prongs are preferably arranged in an array with the prong tips approximately equidistant from each other, such as in an equilateral triangle, square, pentagonal, etc. array. The prongs may also be arranged in an array with a tip profile with one or more center prongs, such as the five dots in a standard die. Embodiments with multiple prongs enable the user to target smaller specimens with greater probability of spear penetration versus a single or even 3-pointed spear tips which are commonly on the market. Prongs of the spear are preferably at least 2 inches long, more preferably at least 3 to 4 inches long, most preferably about 5 to 6 inches long. According to a preferred embodiment, the spear head is comprised of a single piece of metal with four prongs emanating from a circular base that are approximately straight longitudinally. This spear head design provides for the maximum tip capture area, while easily fitting within the launching device. According to a preferred embodiment, the prong tips are approximately 1 inch from one another. Preferably, the spear head is made of a rigid yet non-corrosive material, such as stainless steel. Such materials include without limitation aluminum, fiberglass or steel, preferably, stainless steel. The spear head is affixed to one end of the shaft via any means that provides for secure assembly, including but not limited to one or multiple set screws 3 around the perimeter of the spear head opposite the prongs, adhesives, rivets, matching threading for the spear head and shaft, clamps, or any other means of attachment. Likewise, the spear and the shaft may be formed as a single unitary piece. In the embodiment shown in FIG. 1, the spear head is securely attached to the shaft using a stainless steel set screw 3 inserted through the base of the spear head and pressing into the shaft 1. Preferably, both the spear head and the shaft may be replaced on a given spear. In these embodiments, the spear head may be affixed via any means that allows for easy disassembly, such as perimeter screws or screwing the head directly into the shaft. The end of the spear opposite the spear head is the launch end 19, which according to at least one embodiment may have a notched end 11 sized to fit appropriately on an elastic tension band.

The spear shaft 1 is preferably made from a non-corrosive material such as fiberglass, plastic, wood, stainless steel, and other materials that will withstand salt water. The spear shaft 1 preferably has slightly textured exterior surface to aid in gripping underwater thereby reducing accidental injuries or lost spears. The spear shaft 1 is of a diameter to enable it to slide freely through the hole provided 10 in the fixed rearward end cap 5. The spear shaft 1 may be notched at its base 11 much like an arrow shaft would be. The function of this notch is to firmly seat the spear shaft base into the midline of the looped end of the power band 6 when preparing the weapon for use. The spear head base 2 shall be of a diameter so as to easily and firmly receive the spear shaft 1 selected.

The length of spear shaft 1 utilized will be determined by the length of the cylindrical body 4 selected by the user. In each case of varying length, the launch end 19 of the spear shaft 1 should protrude through the base cap hole 10 by approximately at least 2-3 inches in the resting position. Furthermore, in this resting position with the weapon assembled, the points of the spear head will be touching the inside of the muzzle end cap 20.

In preferred embodiments, the perimeter of the shaft 1 is not smooth around the perimeter (as depicted in FIG. 1), but is rough or texturized to provide for easier grip and handling of the projectile spear at the shaft. Protective coatings may be applied to part or all of the shaft, spear head, or the entire projectile spear, including but not limited to paints, sealants, and rubberized coatings. Coatings and other products may also be used to provide a further texturized surface of the shaft or to provide an easier grip surface. Preferably, a coating is applied to at least the shaft of the projectile spear to protect the shaft from the salt water environment, which allows for the shaft to be made of a less corrosion-resistant base. In a preferred embodiment, the shaft is comprised of texturized fiberglass rebar with a rubberized protective coating applied to the shaft and the base of the spear head, leaving the stainless steel prongs exposed.

According to several embodiments of the invention as shown in the figures, the spear head has a unique design limiting travel of the speared fish. That is, the fish can not slide down the spear more than a couple of inches thereby reducing the probability of accidental sting as occurs when using traditional pole spears. The spear should be of sufficient mass and balanced such that it can be propelled (as explained further below), while still being lightweight and easy to use underwater. The mass of the projectile spear will be dependent on its length, and projectile spears as light as approximately 3 oz have been successfully tested in embodiments of the assembly.

Views of projectile assemblies according to some embodiments of the present invention are shown in FIGS. 2-7. The invention also comprises a cylindrical barrel 4, which is a rigid cylinder or tube with a relatively consistent inner diameter. Preferably, the cylindrical barrel has relatively smooth, or at least of consistent cross sectional profile, interior walls. The cylindrical barrel can be made from a variety of non-corrosive materials including PVC, plastic, wood, stainless steel, and other appropriate materials. The cylindrical barrel 4 can vary in length from approximately 10-30 inches, preferably 12-24 inches, more preferably 15-16 inches.

According to several embodiments of the invention, the body has sets of 2 shallow notches cut into the outside wall of the cylindrical barrel 4 in various locations or on the attached handle 9. These notches serve to inhibit the movement of the ends of the elastic tension band 6 and removable end cap 20 retainer 13. In an embodiment, notches may be used to assist in attaching the elastic tension band 6 to the cylindrical barrel or the attached handle 9. In some embodiments, these notches are at the approximate mid-line of the cylindrical barrel 4. In other embodiments, the notches are approximately ⅔ to ¾ of the distance from the launch end 26 of the cylindrical barrel. In other embodiments, the notches were placed approximately 7 to 9 inches from the launch end 26 of the cylindrical barrel 4. The exact location and measurements of these notches will vary according to the overall length and diameter of the tube that comprises the cylindrical barrel and the corresponding length and weight of the projectile spear. Notches may include small indentations of various sizes and shapes, ranging in length from a few millimeters to around the perimeter of the cylinder. They may include round, oval, circular, or other shapes. They may be a millimeter or more in depth. Notches may also include holes, which may be round, oval rectangular, or of other shapes, cut into the handle or cylinder.

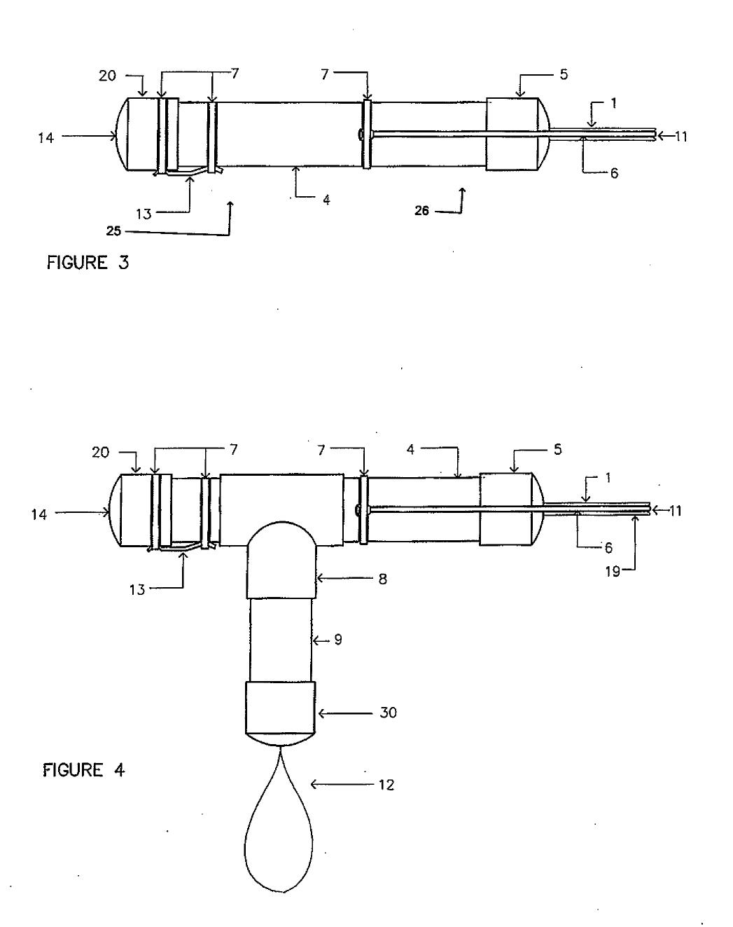

In preferred embodiments as shown in FIGS. 2-7, the body has 2 end caps 5 and 20. The launch cap 5 is firmly attached to the launch end of the barrel 26 and the muzzle end cap 20 is optionally attached to the muzzle end 25 of the barrel but removable. According to some embodiments as shown in FIGS. 3, 4, 6, and 7, the muzzle end cap 20, though removable, has affixed to it a muzzle end cap keeper 13, which is a length of elastic or other flexible material to keep the muzzle end cap in proximity to the cylindrical barrel but not affixed longitudinally to the end, in order to retain it closely for subsequent reattachment to the body 4 and avoid loss in the water. According to some embodiments, notches may be located in the outer edge of the cylindrical barrel between the longitudinal middle of the cylindrical barrel and the muzzle end of the cylindrical barrel to keep the muzzle end cap 20 in place. In other embodiments, notches may also be placed in the outer edge of the cylindrical barrel between the attached handle and the muzzle end of the cylinder 25 to affix the muzzle end cap 20. In some preferred embodiments, the keeper notches are about 1½ to 2½ inches from muzzle-end of the cylindrical barrel 4.

The firmly attached launch end cap 5 has a hole about its centerline 10. The diameter of the guide hole 10 provided is larger than the spear shaft 1 selected, preferably only slightly larger. Ultimately, the spear shaft 1 must move (slide) very freely forward and rearward (aft) through this guide hole 10 with a minimum of friction. The centered location of this guide hole 10 plays an important part in guiding the spear accurately down the centerline of the cylinder 4 with a minimum of friction thereby increasing accuracy and maximizing effective distance.

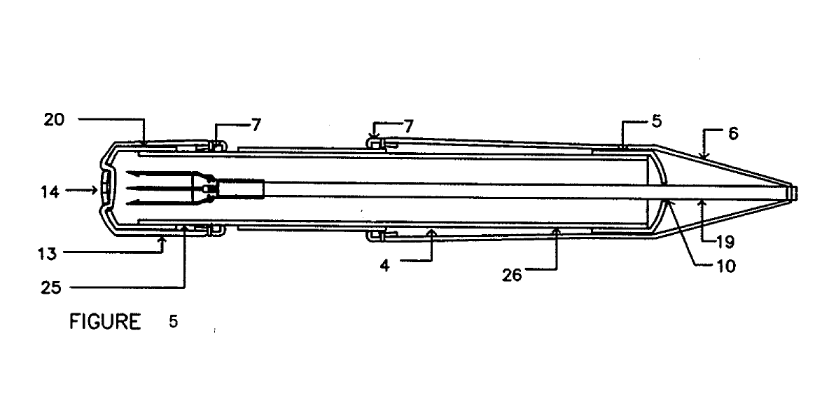

According to several embodiments as shown in FIGS. 2-7, the muzzle end cap 20 serves as a safety device. It protects the user from contact with the sharp ends of the spear head 2 when not in use. Optionally, the muzzle end cap 20 may have one or more small holes 14 about its center to facilitate attachment of the end cap retainer 13 and aid in water drainage. The muzzle end cap 20 is removable. As shown the embodiments shown in FIGS. 2-7, attached to the muzzle end cap is a length, or lengths of elastic material 13 to aid in retaining it to or against the body 4 of the cylinder. Put more simply, in these embodiments, the muzzle end cap 20 is held in place on the cylinder 4 by the elastic material 13, adding to the safety factor of this device. In these embodiments, the retaining material 13 also prevents the muzzle end cap 20 from being lost once removed. As previously described, the retaining material 13 may be held in place utilizing shallow notches cut in the cylindrical body 4 or handle. The retaining material 13 can be secured in place at the notches provided utilizing wrapped line, wire, nylon ties, fabric etc. around the perimeter of the cylindrical barrel. In the embodiments shown in FIG. 3 and FIG. 4, the muzzle end cap is attached to the cylindrical barrel 4 by a single strand of retaining material 13 secured on one end with a tie around the perimeter of the cylindrical barrel and on the other end to around the perimeter of the muzzle end cap. In the embodiments shown in FIGS. 5, 6, and 7, the muzzle end cap is attached to the cylindrical barrel 4 that extends over the cap end of the muzzle end cap and attaches at two points to the cap end of the muzzle end cap by threading the retaining material through two holes in the muzzle end cap. Other means of attaching the muzzle end cap 20 to the cylindrical body 4 may also be used.

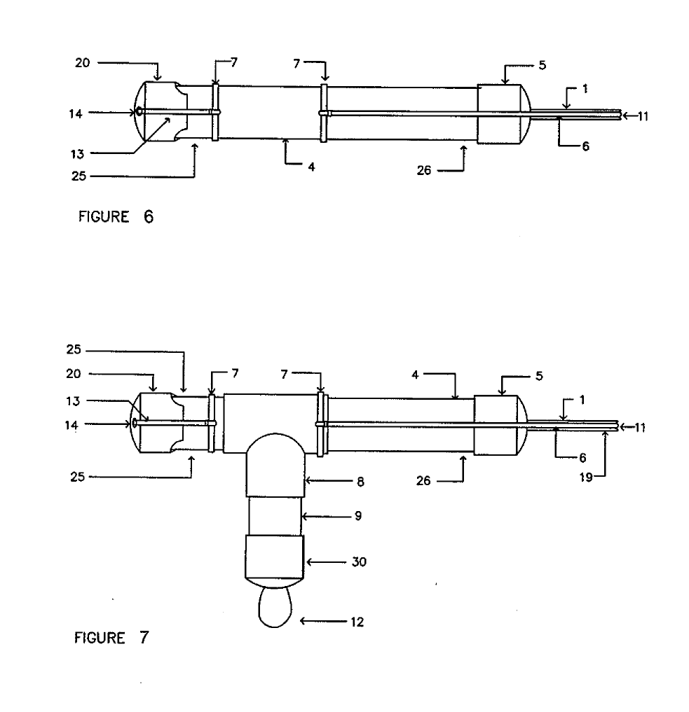

The muzzle end cap may be of any shape or design to adequately cover the muzzle end or exit end of the cylindrical barrel of the launcher. In some preferred embodiments such as those shown in FIG. 6 and FIG. 7, the edge of the muzzle end cap that faces the launch end of the cylindrical barrel when the cap is on the cylindrical barrel has a scallop or arch cut into both the top and bottom edge. In these embodiments the arcs are shaped be based on those of a circle with an radius of approximately the same radius of the outer radius of the cylindrical barrel 4 of the launcher. This is so that the muzzle end, when removed from the end of the cylindrical barrel 4 by the user, may rest right up against the bottom of the cylindrical barrel.

The projectile spear is launched from the projectile assembly by using an elastic tension band 6. As shown in FIGS. 2-7, an elastic tension band 6 extends around the rearward end 26 of the cylindrical barrel. The two ends of the elastic tension band may be seated in notches 7 on the outside of the cylinder body 4 and firmly affixed to the outside of the cylindrical barrel using, for example, wrapped line or wire, nylon ties, fabric etc. The elastic tension band 6 may be attached directly to the body 4 or to the rearward end of the attached handle 9 as to create a rearward loop of material resting on the fixed rearward end cap 5 in its relaxed state. The elastic tension band may be made of any suitable longitudinally elastic material that may be stretched but will quickly return to its original shape, thus providing power for launch of the spear. Examples of such suitable elastic materials include, without limitation, latex rubber, silicone rubber, elastic polymer, and materials of similar elasticity. The elastic tension band may be made of a single or multiple layers of such materials, including tube formations. In a preferred embodiment, the elastic tension band is made of ⅜ inch diameter surgical tubing.

Embodiments of the invention may optionally include a handle. According to one embodiment of the invention as shown in FIG. 4, the invention may be further comprised of a handle 9. The handle attached to the outside edge of said cylindrical barrel between said band end and muzzle end. According to some embodiments, the handle may be attached by a T-shaped device 8 constructed of similar materials as the cylindrical body 4. It is designed to be firmly attached to the cylindrical body 4. The handle 9 is preferably a length of about 3-4 inches as to fit an average user's hand comfortably. The handle has firmly attached to it a fixed end cap 30 from which extends a small lanyard 12 which can be used to temporarily secure the device to one's BCD.

According to another embodiment, the handle may be detachable from the assembly. According to this embodiment, the handle may be attached to the cylindrical barrel 4 by firmly pressing it onto the cylindrical body until it straps in place. The handle may similarly be removed from the cylinder by pulling the parts apart with enough force to detach them.

According to some embodiments of the invention, the invention is further comprised of one or more attachment straps. According to these embodiments, one or more straps can be attached to the outside of the cylindrical body. These straps can be used to temporarily secure the assembled weapon to the diver's body, such as on the diver's leg or arms. In a preferred embodiment, two straps are attached to the outside of the cylindrical barrel, with one strap attached around the circumference of the barrel and extending outward at a point between the longitudinal middle of the barrel and the muzzle end, with the other strap attached around the circumference of the barrel and extending outward at a point between the longitudinal middle of the barrel and the launch end 26. The portion of the straps extending out from the barrel is preferably about 12 inches long, or another appropriate length as to fit comfortably around a diver's legs or arms. The straps may be made of any material appropriate for underwater use and compatible with attachment to the cylindrical barrel and to a diver's body. Preferable materials for attachment straps include cloth hook and loop closures (such as Velcro) to allow easy attachment and removal either in or out of the water.

In comparison also of these types of spear guns, where transportation underwater require most of the times to be held by the user, and the size and shape that will translate into more water resistance, this invention is quite advantageous, that is, it is easily stowed and it will require two hand operation only prior to be used.

Ergonomic design of the embodiments of the invention allow it to be clipped to the diver's BCD or strapped and carried parallel to the leg, achieving this way a hydrodynamic quality that will be translated into better diver comfort when it's not in use. Traditional spear guns or slings are typically carried in one hand during a dive, greatly encumbering the diver and introducing the possibility of injuring one self, another diver or accidentally contacting and harming the environment (reef).

To attain this, the present invention can accept multiple attachments like the straps first secured to the cylinder that will in turn firmly secure the gun to the leg, allowing the user to adjust the location and level of tightness according to personal preference, or the option to have a handle attached for better performance and ergonomic advantages on continuous shots. In addition, the handle may also have attached a lanyard or a looped length of cord 12 or other material thereby allowing temporary attachment to the diver's BCD.

Embodiments of the present invention also include the safety features, such as the launch end cap, that allow it to be carried without concern of the sharp points, giving great maneuverability to the user in or out of the water.

Ergonomic design that allows it to be carried parallel to the leg, achieving this way a hydrodynamic quality that will be translated into more comfort and less water resistance when it's not in use.

The barrel, handle, and other parts of the present invention may be made with non-corrosive materials, such as industrial grade plastic-base materials that it is made of; giving it this way an advantage when it comes to routine maintenance due to salt water exposure.

Embodiments of the present invention are preferably symmetrically designed along a longitudinal axis. Such symmetric design would not distinguish whether the user is right handed or left handed, and the potential energy being stored by the power band is achieved with the stretching efforts by a person of average strength.

It is yet still another object of this invention to provide a gun that can be advantageously used underwater, but which, because of its versatile construction, is not limited to such usage.

To attain this, the present invention can house multiple attachments like the straps that are firmly secured to the leg, allowing the user to adjust the level of tightness according to personal preference. Other optional attachments include but are not limited to underwater flashlights, sight devices, and small underwater cameras. These devices may be attached to the cylindrical barrel 4 or the top of the handle using one or more straps, hook and loop straps, snaps, with tie cords, zip ties, screws, or any other feasible means of attachment.

Because the present invention is normally used as a limited range weapon for use in very close proximity (usually within 1 foot or less) to the subject, there is no need for it to be over powered. This novel and unique aspect will result in greater accuracy, better percentage of successful hits, reduced personal injuries and more importantly, have less impact on the surrounding reef. Less collateral damage to the reef system will occur verses using conventional spear guns or pole spears.

The invention also includes methods for capturing lionfish or other underwater specimens. These methods involve using the projectile assemblies that have been described herein. The hunter or specimen collector aligns the projectile assembly with the prey or specimen to be captured by pointing the muzzle end of the cylindrical barrel at the prey or specimen. The projectile spear should be within the cylindrical barrel with the launch end of the spear facing the band end of the barrel. If there is a muzzle end cap on the projectile assembly, it should be removed either while aligning or prior to aligning. The launch end of the spear should be against the elastic tension band of the launcher, preferably near the band middle. The hunter should hold the launcher steady with one hand, keeping it aligned with the prey, and using fingers of the other (second) hand pull or press the shaft of the projectile spear against the elastic tension band and pull both longitudinally away from the muzzle end of the projectile assembly to increase tension in the elastic tension band. The hunter's second hand may be actually touching the projectile spear shaft, the elastic tension band, or both. When the hunter is ready to launch the projectile spear, he or she should release the spear and/or the elastic tension band with the second hand, holding the assembly steady with the first hand, thus launching the spear down the muzzle end of the tube and out of the tube to make contact with the prey or specimen. If the hunter has aimed correctly, the prongs of the projectile spear should make contact with the prey or specimen and become embedded in the prey or specimen. The hunter can then collect the prey or specimen by grabbing the shaft of the projectile spear without actually touching the specimen. This is particularly advantageous when capturing venomous lionfish. The prey or specimen may then be pulled off the prongs of the projectile spear and into a collection bag or other repository.

Another advantage that the projectile assembly has over the prior art is that it has a built-in method for releasing the prey. Oftentimes, when a hunter uses embodiments of the projectile assembly, the projectile spear only travels a few inches before embedding it its prey and the projectile spear is still largely within the cylindrical barrel. Even when this is not the case, the speared prey can be easily extracted off of the spear end simply by reinserting the projectile spear's shaft base back into the cylinder to the fullest extent, toward the launch end, grabbing the base of the shaft as it passes through the hole and pulling the spear in a rearward direction thereby pressing the prey against the muzzle end of the cylindrical base and ejecting the fish off of the pointed ends of the spear. A collection bag may be attached to or wrapped around barrel near the muzzle end after the prey is speared but before the fish is ejected from the spear. This extraction method allows the user to remove the venomous fish from the spear without touching it or even getting close thereby reducing the probability of getting accidentally stung by this prey (a common occurrence with divers using traditional pole spears and the like). The specimen can then be carefully placed into a collection bag, placed back onto the reef once terminated or can be presented to a prospective natural predator such as a grouper, snapper, eel, lobster etc.

I claim:

1. A projectile assembly for underwater hunting and specimen collection comprising:
(a) a cylindrical barrel comprising a band end and a muzzle end;
(b) a projectile spear comprising a shaft, a launch end and pronged end;
(c) an elastic tension band attached to said cylindrical barrel, comprising a first band end attached to a point on the outer edge of the band end of said cylindrical barrel, a second band end attached to a second point lateral to said first point on the outer edge of the band end of said cylindrical barrel, and a band middle;
whereas the projectile spear is launched by first placing said projectile spear within said cylindrical barrel with said launch end of the spear facing the band end of the barrel with said elastic tension band and placing said launch end against the band middle,
then pulling the band middle away from said cylindrical barrel,
then releasing said band middle to launch said projectile spear from the muzzle end of said cylindrical barrel.

2. The projectile assembly as claimed in claim 1, further comprising
(d) a launch cap attached to said band end of said cylindrical barrel, said launch cap including a guide hole in the center of said launch cap, the diameter of said guide hole being larger than the diameter of said shaft of said projectile spear; and
whereas said projectile spear is launched by first placing said projectile spear within said cylindrical barrel with said launch end of the spear facing the band end of the barrel with said elastic tension band and,
pulling said launch end of said projectile spear through the hole in said launch cap and placing said launch end of the projectile spear against the band middle,
then pulling the band middle away from said cylindrical barrel,
then releasing said band middle to launch said projectile spear from the muzzle end of said cylindrical barrel.

3. The projectile assembly as claimed in claim 1, further comprising:
(e) a removable muzzle end cap initially around the outside of the muzzle end of said cylindrical barrel,
whereas said muzzle end cap is removed from the muzzle end of said cylindrical barrel prior to releasing said band middle.

4. The projectile assembly as claimed in claim 1, further comprising:
(f) an assembly handle attached to the outside edge of said cylindrical barrel between said band end and muzzle end.

5. The projectile assembly as claimed in claim 1, wherein said projectile spear pronged end comprises at least 3 prongs.

6. The projectile assembly as claimed in claim 1, wherein said projectile spear pronged end comprises at least 4 prongs.

7. The projectile assembly as claimed in claim 1, further comprising:
(g) one or more projectile assembly attachment device,
whereas said projectile assembly attachment device attaches to the cylindrical barrel by wrapping around said barrel and extending outward, and
whereas said projectile assembly device may further be wrapped around a diver's arm, leg, or other part.

8. The projectile assembly as claimed in claim 1, wherein said cylindrical barrel is at least 12 inches long.

9. The projectile assembly as claimed in claim 1, wherein said cylindrical barrel is about 12 inches to about 30 inches long, and said projectile spear is about 15 inches to about 33 inches long.

10. The projectile assembly as claimed in claim 1, wherein said cylindrical barrel is about 12 inches to about 24 inches long and said projectile spear is about 15 inches to about 27 inches long.

11. The projectile assembly as claimed in claim 1, wherein said elastic tension band is attached to said cylindrical barrel by a wrapped line, wire, nylon ties, or elastic band around the outer edge of said cylindrical barrel.

12. The projectile assembly as claimed in claim 3, wherein said muzzle end cap is attached to the outside edge of said cylindrical barrel with a cap retaining cord, and whereas when said muzzle end cap is removed from the muzzle end of the cylindrical barrel, said muzzle end cap remains attached to the outside edge of said barrel by the cap retaining cord.

13. The projectile assembly as claimed in claim 3, wherein said muzzle end cap is attached to two points along the outside edge of said cylindrical barrel with an elastic retain cord, and whereas the lower edge of the muzzle end cap includes indentations such that the muzzle end cap can rest against the bottom edge of the cylindrical barrel.

14. The projectile assembly as claimed in claim 4, said assembly handle comprising a handle loop attached to said handle, wherein said handle loop may be placed around diver's belt, buoyancy control device, or other appendage or portion of diving gear.

15. A method for a hunter to capture underwater prey comprising:
(a) aligning a projectile assembly with the prey, said projectile assembly comprising:
(i) a cylindrical barrel comprising a band end and a muzzle end;
(ii) a projectile spear comprising a shaft, a launch end and pronged end;
(iii) a launch cap attached to said band end of said cylindrical barrel, said launch cap including a guide hole in the center of said launch cap, the diameter of said guide hole being larger than the diameter of said shaft of said projectile spear; and
(iv) an elastic tension band attached to said cylindrical barrel, comprising a first band end attached to a point on the outer edge of the band end said cylindrical barrel, a second band end attached to a second point lateral to said first point on the outer edge of the band end of said cylindrical barrel, and a band middle;
said aligning accomplished by aligning the projectile assembly with the prey with the muzzle end of the projectile assembly facing the prey and the launch end of the projectile assembly facing the hunter,
(b) ensuring that the projectile spear is within said cylindrical barrel with said launch end of the spear facing the band end of the barrel with said elastic tension band and placing said launch end against the band middle,
(c) holding the projectile assembly steady with a hunter's first hand,
(d) placing fingers of a hunter's second hand against the launch end of such projectile spear and pulling said projectile spear against the elastic tension band and longitudinally away from the projectile assembly to increase tension in the elastic tension band,
(e) releasing the spear with the second hand, holding the assembly steady with the first hand, thus launching the spear down the muzzle end of the tube and out of the tube to make contact with the prey.

16. The method as claimed in claim 15, said projectile assembly further comprising:
(v) an assembly handle attached to the outside edge of said cylindrical barrel between said band end and muzzle end,
wherein said holding step (c) comprises holding the projectile assembly steady at said assembly handle using a hunter's first hand.

17. The method as claimed in claim 15, further comprising:
(f) retrieving the spear with the prey by grasping the launch end of the spear,
(g) placing the launch end of the spear back into the muzzle end of the cylindrical barrel
(h) pulling the launch end of the spear back through the launch end and the launch hole, whereas said prey is pressed against the muzzle end of the barrel and is released from the spear.
